(19) United States
(12) Patent Application Publication
(10) Pub. No.: US 2008/0254311 A1
(43) Pub. Date: Oct. 16, 2008

(54) PALLADIUM-CONTAINING PLATING SOLUTION AND ITS USES

(75) Inventors: Shih Chung CHEN, Tao Yuan (TW); Yu Ling Kao, Tao Yuan (TW); Min Hon Rei, Tao Yuan (TW); Len Tang Tsai, Tao Yuan (TW)

Correspondence Address: VENABLE LLP, P.O. BOX 34385, WASHINGTON, DC, 20043-9998, US

(73) Assignee: Green Hydrotec Inc., Tao Yuan (TW)

(21) Appl. No.: 11/960,975

(22) Filed: Dec. 20, 2007

(30) Foreign Application Priority Data
Apr. 13, 2007 (TW) 096113137

(51) Int. Cl. B32B 15/01; C25D 3/50; B32B 15/18

(52) U.S. Cl. 428/613; 205/265

(57) ABSTRACT

A palladium-containing electroplating solution and method for providing a palladium or palladium alloy membrane on a porous metal support are provided. The subject invention uses electroplating to manufacture a palladium or palladium alloy membrane on a porous metal with a decreased preparation time and simplified preparation procedure. Moreover, the palladium or palladium alloy membrane prepared by the subject invention exhibits excellent compactness and good resistance to the hydrogen embrittlement, as well as a high applicability.

This application claims priorities to Taiwan Patent Application No. 096113137 filed on Apr. 13, 2007.

### CROSS-REFERENCES TO RELATED APPLICATIONS

Not applicable.

### BACKGROUND OF THE INVENTION

1. Field of the Invention

The subject invention relates to a palladium-containing electroplating solution and a method for preparing a palladium or palladium alloy membrane on a porous metal support by electroplating. The method produces a palladium or palladium alloy membrane that is strongly adhered to the porous metal support, thereby, providing a palladium membrane tube fitting useful for the catalytic reactor during hydrogen purification or synthesis.

2. Descriptions of the Related Art

A palladium or palladium alloy membrane can be prepared using the electroless plating method, the vacuum sputtering method, or the cold-rolled method. For plating a palladium or palladium alloy membrane on a porous metal support, the electroless plating method is conventionally used, such as that disclosed in Taiwan Patent Publication No. 1232888 and U.S. Pat. No. 6,152,987. However, with the electroless plating method, the adhesion to the membrane is dependent on the physical adsorption of the chemically reduced metal particles on the substrate. As a result, the temperature variation can exfoliate the palladium or palladium alloy membrane from the porous metal support. Moreover, in preparing a palladium membrane, the electroless plating method requires multiple depositions (more than 6 to 7 times) to obtain a palladium membrane with the desired thickness. Furthermore, the resulting membrane is subjected to an annealing treatment for homogenization to complete the preparation process. In addition, it is difficult to control the reducing rates of the different cations (e.g., Pd ion, Cu ion, and Ag ion) and the depositing rates. Therefore, multiple steps are required for reducing a single ion and depositing the individual metal layers, and then, an annealing step is carried out at a high temperature for a long time to obtain an alloyed metal layer comprising two or more metals. In other words, the electroless plating method is slow and results in poor adhesion.

As mentioned above, the palladium membrane can be electroless plated on a porous metal support. The palladium or palladium alloy membrane has also been electroless plated on a porous ceramic support as disclosed in Japan Laid-Open Patent Application No. 2002-119834 and No. 2002-153740. Because the porous ceramic or glass support has a compact surface with nano-sized pores (10-200 nm), the palladium or palladium alloy membrane can easily block the pores, and thus, create a better plated membrane. However, the porous support materials with nano-sized pores are expensive and their manufacturing costs keep this product noncompetitive in the market.

In the vacuum sputtering method for preparing a palladium or palladium alloy membrane, the expensive vacuum apparatus and sputtering targets involved therein also drive the manufacturing costs high and are thus, undesirable in the market.

As for the use of the cold-rolled method for preparing a palladium or palladium alloy membrane, the resulting membrane needs to adhere onto the porous support in a specific way. Therefore, the procedures are complicated, and the membrane suffers from poor adhesion and a low manufacturing yield. Such a method is also unattractive.

The technology known at present for electroplating a palladium or palladium alloy membrane is primarily applied to common supports with a smooth surface mainly for the purpose of processing or decoration. For example, the technology of electroplating a palladium or palladium alloy membrane on a smooth surface is typically applied to ornaments such as jewelry to prevent the decoloration due to the oxidation on their surfaces or electronic components to improve the weldability. This technology decreases the contact resistance, and enhances the anti-oxidation properties. The resulting membrane has a thickness ranging from about 0.3 mm to about 2 mm, such as that disclosed in U.S. Pat. No. 4,486,274. However, when the formulation of the palladium salt electroplating solution employed in such known technology is applied to the electroplating of porous metal supports, it is impossible to obtain a compact palladium or palladium alloy membrane free of defects. In fact, the resulting plated membrane has some pinholes thereon, rendering it unsuitable for purifying elements used for supplying H₂ with high purity.

As a result, there is a common desire in the industry to provide a method for preparing a palladium or palladium alloy membrane, with the desired compactness and H₂ permeability, on a porous metal support in a more simple, timesaving and economical way.

### SUMMARY OF THE INVENTION

One objective of the subject invention is to provide a palladium-containing electroplating solution, which comprises palladium sulfate, a reactive conductive salt, a complexing agent, and a buffering agent.

Another objective of the subject invention is to provide a method for providing a palladium or palladium alloy membrane on a porous metal support, which comprises providing a porous metal support; and electroplating a palladium or palladium alloy membrane onto the porous metal support with a palladium-containing electroplating solution. Said palladium-containing electroplating solution comprises a palladium salt, a reactive conductive salt, a complexing agent, and a buffering agent.

Yet a further objective of the subject invention is to provide a composite with a palladium or palladium alloy membrane, which comprises a porous metal substrate; a medium layer coated on a surface of the substrate; and a palladium or palladium alloy membrane coated on the medium layer. The palladium or palladium alloy membrane is substantially free from exfoliation under the condition that the pressure at the substrate side of the composite is up to about 3 absolute atmospheres higher than the pressure at its palladium or palladium alloy membrane side.

### BRIEF DESCRIPTION OF THE DRAWINGS

FIG. 1 shows a flow chart of a method for electroplating a palladium membrane onto a porous metal support in accordance with the subject invention;

FIG. 2 shows electron microscopic photographs of the palladium membranes electroplated at different rotational speeds of the support (A: 10 rpm, B: 20 rpm, C: 50 rpm, D: 100 rpm, E: 500 rpm) in accordance with the subject invention;

FIG. 3A shows an electron microscopic photograph of an electroplated palladium alloy membrane in accordance with the subject invention;

FIG. 3B shows the composition analysis result of an electroplated palladium alloy membrane in accordance with the subject invention;

FIG. 4 shows an electron microscopic photograph of a palladium membrane electroplated using a two-stage electroplating treatment in accordance with the subject invention; and

FIG. 5 is a schematic view of a palladium membrane shell and tube reactor;

FIG. 6 is a photograph showing the result of a hydrogen embrittlement test on a conventional electroless plated palladium membrane;

FIG. 7 is a photograph showing the result of a hydrogen embrittlement test on an electroplated palladium membrane of the subject invention; and

FIG. 8 is a schematic view of a reactor utilizing the palladium membrane of the subject invention.

### DESCRIPTION OF THE PREFERRED EMBODIMENT

The subject invention provides a palladium-containing electroplating solution, which comprises palladium sulfate, a reactive conductive salt, a complexing agent, and a buffering agent. In the electroplating solution, there is about 2 g/L to about 200 g/L of palladium in the palladium sulfate and preferably about 5 g/L to about 50 g/L. There is also about 10 g/L to about 200 g/L of the reactive conductive salt and preferably, about 70 g/L to about 150 g/L. There is about 10 g/L to about 150 g/L of the complexing agent and preferably, about 30 to about 70 g/L. There is enough buffering agent to render the electroplating solution to have a pH of about 9 to about 12, preferably about 10 to about 11.

In the palladium-containing electroplating solution of the subject invention, the reactive conductive salt can provide conductive ions to enhance the conductivity of the electroplating solution, so as to improve the deposition efficiency and the quality of the palladium or palladium alloy membrane. The reactive conductive salts suitable for the subject invention comprise SO₄²⁻ ion-providing compounds, and can also be selected from a group consisting of salts of Group IA metals, ammonium salts, and combinations thereof. When the SO₄²⁻ ion-providing compound is used as the reactive conductive salt, it can not only enhance the conductivity of the electroplating bath, but also facilitate the dissolution of palladium sulfate with a low solubility. Then, the palladium concentration in the electroplating bath is increased to further enhance the conductivity. For example (but not limited thereto), the reactive conductive salt used in the subject invention can be selected from a group consisting of sodium chloride, potassium chloride, sodium sulfate, ammonium sulfate, ammonium chloride, sodium thiosulfate, ammonium thiosulfate, ammonium citrate, and combinations thereof. The preferred reactive conductive salt is ammonium sulfate.

As known by those skilled in the art, the main purpose of the complexing agent is to improve the stability of the electroplating system. In general, the complexing agent useful for the subject invention can be selected from a group consisting of boric acid, phosphate salts, hypophosphate salts, nitrate salts, tartrate salts, citrate salts, salts of ethylene diamine tetracetic acid (EDTA), and combinations thereof. The salts of EDTA typically used are Group IA metal salts and/or Group IIA metal salts of EDTA. For example (but not limited thereto), the complexing agent can be selected from a group consisting of the following: boric acid, sodium phosphate, sodium hydrogen phosphate, sodium hydrogen hypophosphate, sodium nitrate, potassium nitrate, sodium potassium tartrate, sodium citrate, potassium citrate, ammonium citrate, ethylene diamine tetracetic acid disodium salt (EDTA-Na₂), ethylene diamine tetracetic acid tetrasodium salt (EDTA-Na₄), ethylene diamine tetracetic acid dipotassium salt (EDTA-K₂), ethylene diamine tetracetic acid tripotassium salt (EDTA-K₃), ethylene diamine tetracetic acid magnesium salt (EDTA-Mg), and combinations thereof. The complexing agent is preferably selected from a group consisting of potassium nitrate, ammonium citrate, EDTA-Na₂, EDTA-Na₄, and combinations thereof.

The buffering agent in the palladium-containing electroplating solution of the subject invention serves to decrease the deposition rate of palladium. More specifically, as a noble metal, palladium has a standard reduction potential of up to 0.997 V (i.e., the reducing reaction occurs very quickly). Therefore, to control the entire electroplating process, a buffering agent is normally added to the electroplating solution to slow down the reducing reaction of the palladium metal, so that a uniform palladium or palladium alloy membrane can be formed onto the support. Generally, the OH⁻ ion itself can yield the desired buffering effect, so any suitable hydroxide can be used in the subject invention as a buffering agent. For example (but not limited thereto), the hydroxide selected from a group consisting of the following can be employed as the buffering agent in the palladium-containing electroplating solution of the subject invention: sodium hydroxide, potassium hydroxide, ammonium hydroxide, and combinations thereof. The preferred electroplating solution of the subject invention is ammonium hydroxide.

In addition to the components described above, sulfuric acid may be optionally added to the palladium-containing electroplating solution of the subject invention to facilitate the dissolution of palladium sulfate. The amount of sulfuric acid added depends on the amount of palladium sulfate. Normally, the amount of sulfuric acid renders the concentration of SO₄²⁻ in the electroplating solution to be about 0.2 mole to about 4 moles, and preferably, about 0.5 mole to 2 moles per liter.

The palladium-containing electroplating solution of the subject invention can also be used to deposit a palladium alloy membrane. The palladium-containing electroplating solution further comprises a corresponding metal (a second metal) salt, for example, a copper salt, a silver salt, a gold salt, a nickel salt, a platinum salt, an indium salt, and combinations thereof. The content of the second metal salt varies with the species of the second metal. In one embodiment of the subject invention, the palladium-containing electroplating solution further contains a copper salt to form a palladium-copper alloy membrane. In this case, a copper salt such as copper sulfate or copper chloride can be employed in an amount ranging from about 0.2 g to 100 g of copper per liter of the electroplating solution. In the case of the addition of the second metal, the above complexing agent, in addition to increasing the stability of the electroplating solution, can also form a complex with a metal that has a higher (or lower) reduction potential to decrease (or increase) the standard reduction potential thereof. In this way, the reduction potentials of the two metals are adjusted closer, so as to be deposited together onto a surface of the support to form a uniform palladium alloy membrane.

The subject invention further provides a method for providing a palladium or palladium alloy membrane on a porous metal support, comprising the following steps:

providing a porous metal support; and

electroplating a palladium or palladium alloy membrane on the metal support with a palladium-containing electroplating solution, wherein said palladium-containing electroplating solution comprises:

2 g/L to 200 g/L of palladium in a palladium salt;

10 g/L to 200 g/L of a reactive conductive salt;

10 g/L to 150 g/L of a complexing agent; and

enough buffering agent to give the electroplating solution a pH of about 9 to 12.

In accordance with the method of the subject invention, any porous metal supports can be used, such as (but not limited thereto) iron, an iron alloy, copper, a copper alloy, nickel, a nickel alloy, and combinations thereof. The iron alloy is preferred. Economically, the porous stainless steel cataloged as the iron alloy is the electroplating support of choice.

In the method of the subject invention, the electroplating step is carried out under a current density ranging from about 0.01 A/dm² to about 1.5 A/dm² and preferably, about 0.2 A/dm² to about 1.0 A/dm². The electroplating bath temperature ranges from about 40° C. to about 90° C., and preferably, about 40° C. to about 60° C. Moreover, the metal support can be optionally rotated during the electroplating step at a speed of not higher than 1000 rpm.

In addition to the palladium sulfate, the method of the subject invention can also employ a palladium salt selected from a group consisting of palladium tetrammine chloride (Pd(NH₄)₄Cl₂), palladium ammonium chloride (Pd(NH₄)₂Cl₄), palladium chloride, and combinations thereof. The content of the palladium salt in the electroplating solution ranges from about 2 g/L to about 200 g/L (as palladium), and preferably, about 5 g/L to about 50 g/L. The details of the species and amount of reactive conductive palladium, complexing agent and buffering agent can be found in the above description regarding the palladium-containing electroplating solution of the subject invention, and thus, are not further described herein.

In the method of the subject invention, the electroplating of the palladium or palladium alloy membrane can be done by one electroplating treatment using an electroplating solution with a single palladium salt or through multiple electroplating treatments using an electroplating solution containing two or more palladium salts. Moreover, for the multiple electroplating treatments, the electroplating solution of each treatment can contain the same or different palladium salts. For example, the first electroplating treatment may be carried out with an electroplating solution containing palladium sulfate as the palladium salt to electroplate a thin palladium membrane on the support, followed by a subsequent electroplating treatment with an electroplating solution containing palladium chloride as the palladium salt to provide a palladium membrane with the desired total thickness. In this case, due to the relatively cheap price of palladium chloride, the preparation of the desired plated membrane using the aforesaid two-stage electroplating manner saves costs for electroplating of a palladium or a palladium alloy membrane. Alternatively, the first electroplating treatment can be carried out using an electroplating solution containing palladium chloride as the palladium salt, followed by a subsequent electroplating treatment using an electroplating solution containing palladium sulfate as the palladium salt. Additionally, the second plating treatment can be carried out with any appropriate methods, such as the electroplating method, the electroless plating method, the vacuum sputtering method, or the cool-rolled method.

During the electroplating process of a palladium or palladium alloy membrane, the palladium ions accept the electrons at the cathode to deposit onto the support as the metal Pd. Simultaneously, H₂ is generated at the cathode. Both the H₂ deposits and the metal Pd on the support cause an embrittlement susceptibility of the palladium-containing membrane. To avoid such embrittlement susceptibility incurred by the H₂, it is possible to generate turbulence during the palladium or palladium alloy electroplating process to mitigate or prevent the disturbance from H₂. Any appropriate means may be employed to generate the turbulence, for example (but not limited thereto), rotating the porous metal support as described above, and/or producing a desired turbulence through water flow agitation, air agitation, cathode agitation, or ultrasonic agitation. It has been found that when a porous metal support is rotated to produce the turbulence, the faster the support is rotated under the same current density, the better the resulting palladium or palladium alloy membrane (that is, the membrane exhibits a more compact lattice structure). In accordance with the subject invention, the rotational speed of the metal support is generally not higher than about 1000 rpm, and is preferably controlled within a range from about 100 rpm to about 500 rpm.

In the method of the subject invention, the porous metal support can optionally be treated with some preprocesses before the electroplating step, such as degreasing, welding, and leveling. In particular, almost all porous metal supports commercially available at present are stained with greasiness thereon, which will isolate the electroplating solution from the support and adversely affect the electroplating effect. This isolation eventually leads to blistering, peeling or chipping of the resulting membrane. Generally, to avoid such an adverse phenomenon, an organic solvent such as toluene or acetone was used for cleaning the greasiness both inside and outside the porous metal support. Subsequent to the degreasing process, the porous metal support can also be mechanically polished, using for example sandpaper No. 600, to remove the work-hardening layer formed in the powder metallurgy procedure and the oxidized layer formed in the sintering procedure involved in the preparation of the metal support.

Moreover, the medium layer can be optionally plated onto the porous metal support prior to electroplating the palladium or palladium alloy membrane of the subject invention. Specifically, the medium layer can shrink the pores of the porous metal support (i.e., filling the pores to gradually form a smooth support surface), which is effective in providing a compact palladium or palladium alloy membrane. Additionally, the medium layer can improve the adhesion between the palladium or palladium alloy membrane and the porous metal support to prevent exfoliation and thereby, prolong the service life of the palladium or palladium alloy membrane. For example (but not limited thereto), the medium layer can be composed of a material selected from a group consisting of nickel, copper, silver, gold, platinum, and combinations thereof. The preferred material for the medium layer is nickel. Here, the medium layer can be electroplated two or more times as desired. Meanwhile, the turbulence can be optionally introduced into the electroplating solution during the electroplating process to prevent the disturbance from the H₂ generated therein. The techniques of using a medium layer are described in the articles by the following authors: Renouprez, 1 J. F. et al in Journal of Catalysis, 170, 1997, p. 181, Seung-Eun Nam in Journal of Membrane Science, 153, 1999, p. 163, Seung-Eun Nam in Journal of Membrane Science, 170, 2000, p. 91, and Journal of Membrane Science, 192, 2001, p. 177; all of which are incorporated herein for reference.

The embodiment of the medium-layer electroplating procedure used in the subject invention is described hereinafter with nickel used as the medium layer. In this case, after preprocessing, the porous metal support is placed into a plating vessel for pre-plating the nickel. Here, the temperature of the electroplating bath ranges from about 30° C. to about 50° C. The rotational speed of the support is about 500 rpm. The current density ranges from about 5 A/dm² to about 10 A/dm², preferably from about 7 A/dm² to about 10 A/dm². The electroplating duration ranges from about 3 minutes to about 6 minutes, preferably from about 4 minutes to about 5 minutes. Thereafter, the porous metal support which has been pre-plated with nickel is washed (e.g. by ultrasonic water rinsing), followed by a second nickel-plating procedure in the nickel-plating vessel. In the second nickel-plating procedure, the temperature of the electroplating bath ranges from about 30° C. to about 50° C. The rotational speed of the support is about 500 rpm. The current density ranges from about 2 A/dm² to about 6 A/dm², preferably from about 4 A/dm² to about 6 A/dm². The electroplating duration ranges from about 3 minutes to about 7 minutes, preferably from about 5 minutes to about 7 minutes. Finally, following multiple cycles of water rinsing and drying, a porous metal support plated with a medium layer is obtained.

When the electroplating method of the subject invention is used to provide a tube for H₂ purification, the porous metal support is optionally jointed with other metal fittings of the purification equipment at both ends, subsequent to the degreasing process, using an appropriate method such as argon arc welding. Then, the surface of the porous metal support is mechanically polished as described above to remove the work-hardening layer formed in the powder metallurgy procedure and the oxidized layer formed in the sintering procedure during the preparation of the metal support. The residual imprint of the previously mentioned welding process is also removed. In this way, the porous metal support is guaranteed to have a smooth surface to enhance the effect of the subsequent electroplating procedure. Then, after the smooth metal support is rinsed with water, it is ready for subsequent electroplating.

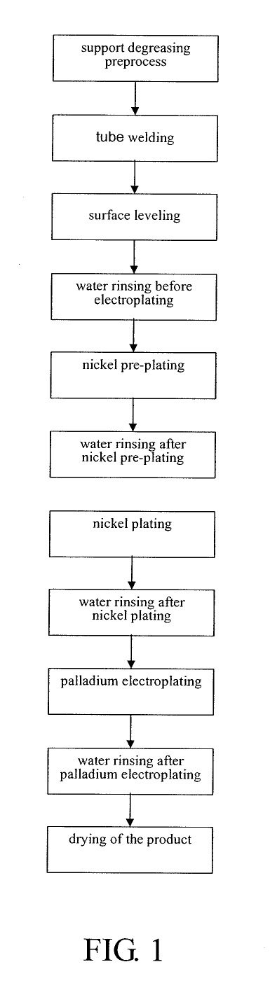

FIG. 1 shows an embodiment of the method for preparing a palladium or palladium alloy membrane on a porous metal support in accordance with the subject invention. As shown in FIG. 1, subsequent to the preprocesses such as degreasing, tube welding and surface leveling, the porous metal support is rinsed with water and optionally dried, followed by a nickel pre-plating, a water rinsing, a nickel plating, a water rinsing, and an optional drying step. Finally, the metal support is electroplated by palladium, washed with water, and dried to provide a metal tube formed from both the porous metal support and palladium membrane.

Hence, the subject invention further provides a composite with a palladium or palladium alloy membrane, comprising:

a porous metal substrate;

a medium layer coated on the surface of the substrate; and

a palladium or palladium alloy membrane coated on the medium layer,

wherein the palladium or palladium alloy membrane is substantially free from exfoliation under the condition that the pressure at the substrate side of the composite is up to about 3 absolute atmospheres, preferably about 5 absolute atmospheres, and more preferably about 10 absolute atmospheres, higher than the pressure at its palladium or palladium alloy membrane side.

In the composite of the subject invention, as described above, the porous metal substrate can be composed of a material selected from a group consisting of iron, an iron alloy, copper, a copper alloy, nickel, a nickel alloy, and combinations thereof. The preferred material is an iron alloy. Economically, the stainless steel cataloged as an iron ally is most preferred. The medium layer interposed between the substrate and the palladium or palladium alloy membrane can be composed of a material selected from a group consisting of nickel, copper, silver, gold, platinum, and combinations thereof. If the stainless steel is employed as the substrate, nickel is preferred as the material for the medium layer.

In comparison to the prior art with the time-consuming electroless plating method, the palladium-containing electroplating solution and the electroplating method for preparing a palladium or palladium alloy membrane on a porous metal support in accordance with the subject invention can eliminate the heat treatment and reduce the preparation time by a factor of 10. Moreover, compared to those prepared by the electroless plating method, the palladium or palladium alloy membrane prepared by the electroplating method of the subject invention exhibits compact crystal grains, and when used in H₂ purification components, it is not inferior to those prepared by the electroless plating method in terms of H₂ permeability. Furthermore, the conventional palladium or palladium alloy membranes are vulnerable to hydrogen embrittlement. In contrast, it has been found that the palladium or palladium alloy membrane of the subject invention is free of hydrogen embrittlement at both low and high temperatures, and therefore has a higher applicability. The hydrogen embrittlement of the conventional palladium or palladium alloy membrane is related to the phase change between the palladium and H₂. The details can be found in the articles written by the following authors: F. A. Lewis in Int. J. Hydrogen Energy, Vol. 21, No. 6, pp. 461-464, 1996, Tea-Hyun Yang et al in Electrochimica Acta., Vol. 41, No. 6, pp. 843-844, 1996, and E. Nowicka et al in Progress in Surface Science, Vol. 48, Nos. 1-4, pp. 3-14, 1995; all of which are incorporated herein for reference.

Exemplary embodiments are provided as follows to further illustrate the subject invention.

### EXAMPLES

### Example 1

### A Palladium Sulfate Electroplating Solution System

### A. Preprocessing a Porous Stainless Steel Support

A porous stainless steel tube was rinsed and degreased with toluene and acetone, and then a 15 cm long section was sliced therefrom and put into an automatic rotational welding machine in alignment with a common metal tube. Argon gas was injected into the tubes at a rate of 8 ml/min to weld them together by the argon arc welding process to obtain a support for electroplating a palladium membrane. Following the welding process, the porous stainless steel support and its welding joint with the common tube were mechanically polished using sandpaper No. 600 for leveling, followed by an ultrasonic water rinsing and a subsequent drying process in an oven at a temperature of 150° C. Then, an He stream at 1 absolute atmosphere was injected into the support to test the gas permeation rate out of the support. The resulting gas permeation rate was 20 L/min.

### B. Electroplating of a Medium Layer

The pre-plated portion of the support had an exposed area of 50 cm². The preprocessed support was put into a nickel pre-plating vessel (with a radius of 120 cm and a height of 200 cm) containing 2 liters of an electroplating solution therein. The composition of the electroplating bath and the electroplating parameters were shown in Table 1. The support was pre-plated to form a nickel coating thereon, and then washed by an ultrasonic water rinsing process. Thereafter, the pre-plated support was again put into a nickel-plating vessel (with a radius of 120 cm and a height of 200 cm) containing 2 liters of an electroplating solution therein. The composition of the electroplating bath and the electroplating parameters were shown in Table 2. Following multiple times of water rinsing, the support was put into an oven for drying at a temperature of 150° C., and then an He stream at 1 absolute atmosphere was injected into the support to test the gas permeation rate out of the support. The resulting gas permeation rate was 4 L/min.

TABLE 1

| Composition of | Amount | | |
|---|---|---|---|
| electroplating bath | (per liter) | Electroplating parameters | |
| nickel chloride | 220 g | temperature | 50° C. |
| boric acid | 40 g | duration | 5 min |
| concentrated | 60 ml | current density | 10 A/dm² |
| hydrochloric acid | | rotational speed | 500 rpm |
| | | of the support | |

TABLE 2

| Composition of | Amount | | |
|---|---|---|---|
| electroplating bath | (per liter) | Electroplating parameters | |
| Nickel sulfate | 350 g | temperature | 50° C. |
| ammonium sulfate | 100 g | duration | 7 min |
| boric acid | 40 ml | current density | 6 A/dm² |
| concentrated | 50 ml | rotational speed | 500 rpm |
| sulfuric acid | | of the support | |

### C. Electroplating of a Palladium Membrane

The resulting support with a nickel medium layer was put into a palladium electroplating vessel (with a radius of 120 cm and a height of 200 cm) containing 2 liters of an electroplating bath therein. The composition of the electroplating bath and the electroplating parameters were shown in Table 3. Following the electroplating process, the support was rinsed with water many times and then dried in an oven at a temperature of 150° C. to finally form a palladium membrane with a compact lattice structure on the porous stainless steel support.

TABLE 3

| Composition of | Amount | | |
|---|---|---|---|
| electroplating bath | (per liter) | Electroplating parameters | |
| palladium sulfate | 5 g | temperature | 50° C. |
| ammonium sulfate | 100 g | duration | 2-2.5 hours |
| concentrated | 70 ml | current density | 0.3 A/dm² |
| sulfuric acid | | rotational speed | 500 rpm |
| potassium nitrate | 20 g | of the support | |
| EDTA-Na₂ | 30 g | | |
| ammonium | sufficient for | | |
| hydroxide | adjusting pH | | |
| | value to 10-11 | | |

### Example 2

### Test of Rotational Speed of the Support

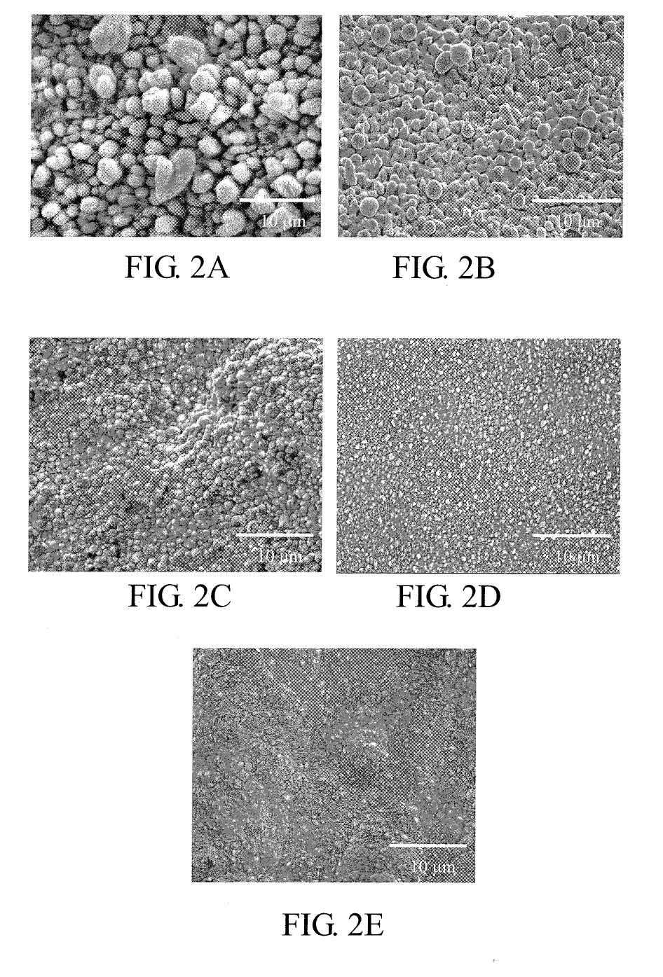

Steps A to C of Example 1 were repeated under the same conditions but at a current density of 1 A/dm² and rotational speeds of 10 rpm, 50 rpm, 100 rpm, 200 rpm, and 500 rpm. Upon the formation of the palladium membrane, the scanning electron microscope (SEM) was used to observe the structure of the resulting palladium membrane. FIG. 2 shows the SEM photographs of the palladium membranes obtained at rotational speeds of 10 rpm (A), 50 rpm (B), 100 rpm (C), 200 rpm (D) and 500 rpm (E), respectively. It can be seen that under the same current density, a higher rotational speed results in a more compact palladium membrane.

### Example 3

### A Palladium Chloride Electroplating Solution System

A palladium membrane was electroplated through steps as the same as steps A to C of Example 1, but using the composition of the electroplating bath and the electroplating parameters listed in Table 4.

TABLE 4

| Composition of | Amount | | |
|---|---|---|---|
| electroplating bath | (per liter) | Electroplating parameters | |
| palladium chloride | 5 g | temperature | 50° C. |
| ammonium sulfate | 100 g | duration | 2-2.5 hours |
| concentrated | 70 ml | current density | 0.3 A/dm² |
| sulfuric acid | | rotational speed | 50 rpm |
| potassium nitrate | 20 g | of the support | |
| EDTA-Na₂ | 30 g | | |
| ammonium | sufficient for | | |
| hydroxide | adjusting pH | | |
| | value to 10-11 | | |

### Example 4

### Preparation of a Palladium-Copper Alloy Membrane

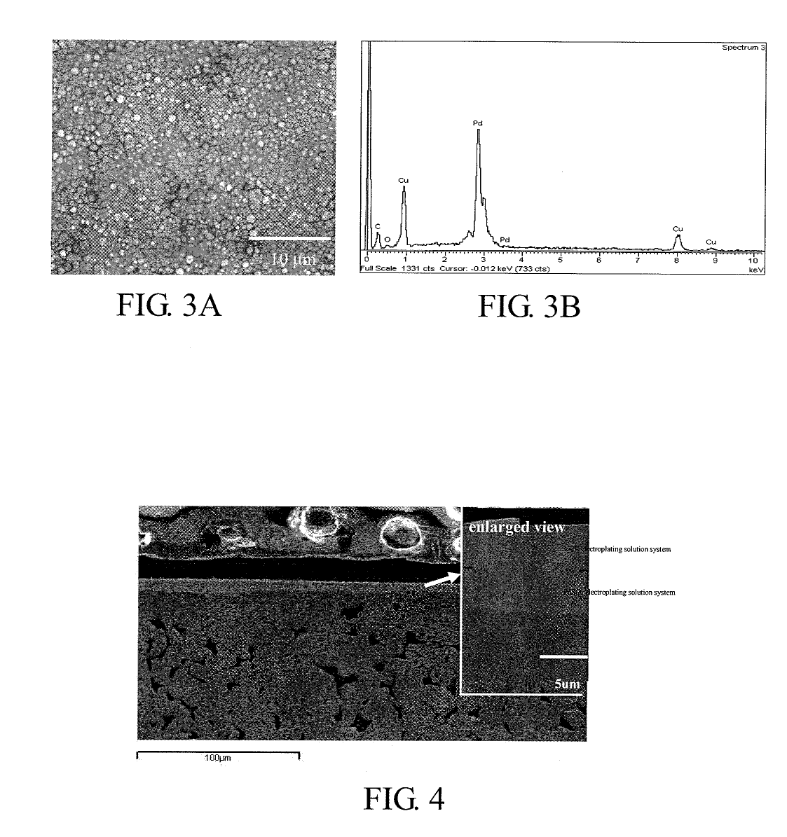

A palladium alloy membrane was electroplated similarly through A to C of Example 1, but using the composition of the electroplating bath and the electroplating parameters shown in Table 5. Upon the formation of the palladium alloy membrane, the scanning electron microscope (SEM) was used to observe the structure of the resulting palladium alloy membrane, as shown in FIG. 3A. Additionally, the composition of the palladium alloy membrane was analyzed with an energy dispersive X-ray (EDX) spectrometer, as shown in FIG. 3B.

TABLE 5

| Composition of | Amount | | |
|---|---|---|---|
| electroplating bath | (per liter) | Electroplating parameters | |
| palladium sulfate | 5 g | temperature | 40° C. |
| copper sulfate | 2 g | duration | 2-2.5 hours |
| ammonium citrate | 100 g | current density | 0.5 A/dm² |
| concentrated | 70 ml | rotational speed | 100 rpm |
| sulfuric acid | | of the support | |
| EDTA-Na₂ | 30 g | | |
| ammonium | sufficient for | | |
| hydroxide | adjusting pH | | |
| | value to 10-11 | | |

### Example 5

### Electroplating with Different Plating Solutions in Sequence

Steps A to C of Example 1 were repeated using the composition of the electroplating bath and conditions shown in Table 3 to electroplate a palladium membrane on a porous metal support. The only difference is that the electroplating lasted for 30 minutes instead. Next, the support was taken out and rinsed with deionized water several times, and then was electroplated with the composition of the electroplating bath and the electroplating conditions shown in Table 4. Upon the formation of the palladium membrane, the scanning electron microscope (SEM) was used to observe the structure of the resulting palladium membrane, as shown in FIG. 4.

### Example 6

### Test on He Permeability

At room temperature, the porous metal support tube with a palladium membrane (referred to as the “membrane tube” hereinafter) obtained from Example 1 was filled with He at 4 absolute atmospheres, and put into a water bath to observe the compactness of the membrane tube. It was found that the He could not penetrate through to the outside of the membrane tube. This meant that the membrane tube could withstand a 4-absolute internal pressure of He.

### Example 7

### Test on Ar Permeability

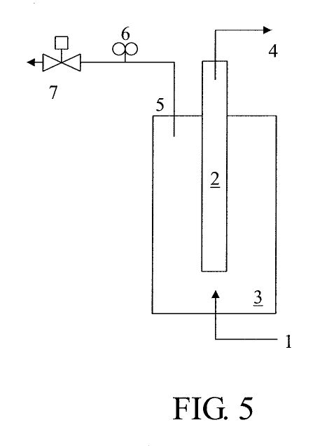

An apparatus shown in FIG. 5 was utilized in this example. The membrane tube (2) obtained from Example 1 was placed into a shell and tube reactor (3). At room temperature, Ar was introduced into the reactor (3) via a gas inlet (1). The outside outlet (5) of the membrane tube was opened so the reactor could be filled with Ar. Then, the outside outlet (5) was closed to build up a backpressure inside the reactor. When the backpressure reached 10 absolute atmospheres, an observation was made in the inside outlet (4) of the membrane tube to check if any Ar had permeated through the pores of the membrane tube into the interior thereof. The test results showed that no Ar from the reactor (3) had permeated through the membrane tube (2) into the interior thereof. This meant that the membrane tube (2) could withstand an external Ar pressure of 10 absolute atmospheres safely.

### Example 8

### Test on H, Permeability

Similarly, the apparatus shown in FIG. 5 and the membrane tube (2) obtained from Example 1 were used in this example. At room temperature, Ar was introduced into the reactor (3) via the gas inlet (1). The outside outlet (5) of the membrane tube was opened so that the reactor (3) could be filled with Ar. Then, the temperature of the reactor (3) was increased from room temperature to 380° C. at a rate of 2.5° C./min, while the inlet gas was replaced with H₂ of industrial level. When the residual Ar was purged completely from the reactor (3) by H₂, a regulating valve (7) on the outside outlet (5) was adjusted to maintain a pressure of 5 absolute atmospheres inside the reactor. Under such a pressure difference, H₂ was driven to permeate through the membrane-plated tube (2) to the inside outlet (4) of the membrane tube, where a permeation ratio of H₂ was measured to be 727 ml/min. Then, the regulator valve (7) on the outside outlet (5) was adjusted to maintain a pressure of 10 absolute atmospheres inside the reactor (3), in which case the permeation ratio of H₂ was measured to be 1481 ml/min. These results demonstrated that the palladium membrane prepared by the subject invention exhibited an excellent H₂ permeability.

### Example 9

### Hydrogen Embrittlement Test

A welded porous stainless steel tube was mechanically polished using sandpaper No. 600, and then was dipped into 10 moles of hydrochloric acid for 3 to 5 minutes and rinsed with deionized water. Subsequently, the resulting tube was immersed into a tin chloride sensitizing solution for 5 minutes, and then was immersed into deionized water for 2 minutes. The tube was then immersed into a palladium chloride activator for 5 minutes and again into deionized water for another 2 minutes. Such a cycle was repeated ten times, after which the activated tube was immersed into an electroless plating solution (comprising palladium ammonium chloride and a reducer hydrazine) to obtain a porous stainless steel tube with a palladium membrane prepared by the electroless plating method (referred to as the “electroless-plated palladium membrane tube” hereinafter).

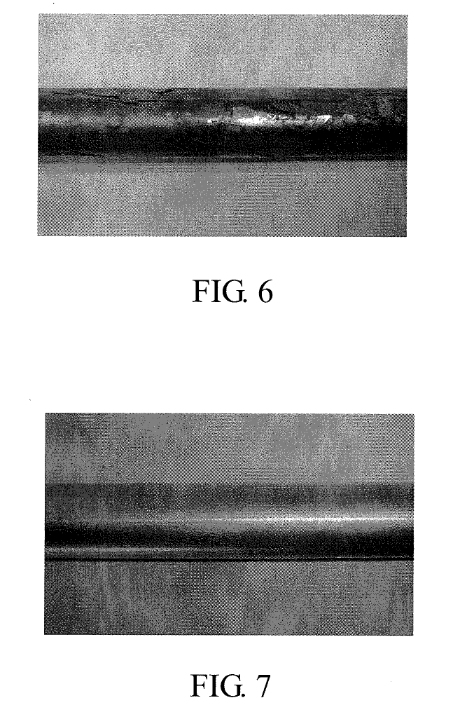

Then, the electroless-plated palladium membrane tube and the tube obtained from Example 1 were subjected to the hydrogen embrittlement test at room temperature. At first, H₂ was injected into the electroless-plated palladium membrane tube to attain a pressure of 3 absolute atmospheres. As shown in FIG. 6, the hydrogen embrittlement and chipping phenomena occurred in the electroless plated palladium membrane. Then, H₂ was injected to the electroplated palladium membrane tube of the subject invention to attain a pressure of 3, 5, and 10 absolute atmospheres, respectively. No hydrogen embrittlement was found.

Next, the operation temperature was increased until the phase change temperature of palladium, i.e., about 250° C. to 300° C., was reached. The electroplated palladium membrane tube of the subject invention was tested again by introducing H₂ to attain a pressure of 3, 5, and 10 absolute atmospheres, respectively. After six hours under the phase change temperature, slow gas leakages were observed in the electroplated palladium membrane tube, but still no chipping occurred, as shown in FIG. 7.

### Example 10

### H₂ Purifying Test

Similarly, the apparatus shown in FIG. 5 and the membrane tube (2) obtained from Example 1 were used in this example. At first, the regulating valve (7) on the outside outlet (5) of the membrane tube was adjusted to maintain a normal pressure inside the reactor (3), and a gas mixture comprising 75% of H₂ and 25% of CO₂ was used as the feeding gas to test the H₂ purity which could be obtained by the membrane tube (2). With a continuous injection of the gas mixture into the reactor (3), the regulating valve (7) on the outside outlet (5) was further adjusted to maintain a pressure of 5 absolute atmospheres inside the reactor (3). Under the resulting pressure differential, H₂ in the reactor (3) permeated through the membrane tube (2) to the inside outlet (4) of the membrane tube. In this case, an H₂ flow rate of 326 ml/min was measured on the outside outlet of the membrane tube (2) with a purity higher than 99.997% (CO, CO₂ and CH₄ in concentrations of lower than 10 ppm). The H₂ flow rate measured on the outside outlet (5) of the membrane tube was 465 ml/min and the content of H₂ was decreased from 57.5% to 75%, which represented a recovery rate of 55%.

Subsequently, the regulating valve (7) on the outside outlet (5) was further adjusted to maintain a pressure of 10 absolute atmospheres inside the reactor (3). Under the resulting pressure differential, the H₂ in the reactor (3) permeated through the membrane tube (2) to the inside outlet (4) of the membrane tube. In this case, the H₂ flow rate of 649 ml/min was measured from the outlet of the membrane tube with a purity higher than 99.997% (all CO, CO₂ and CH₄ in a concentration of lower than 10 ppm). The H₂ flow rate measured on the outside outlet (5) of the plated tube was 794 m/min and the content of H₂ was reduced from 54.6% to 75%, which represented a recovery rate of 60%.

### Example 11

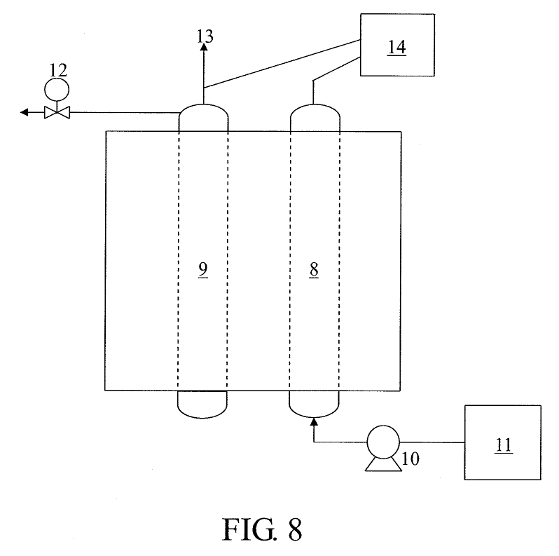

As shown in FIG. 8, a steam reforming reactor (8) and a palladium membrane tube reactor (9) (including the membrane tube obtained from Example 1) were connected in series. At a rate of 2.5° C./min, the temperature of the steam reforming reactor (8) was increased from room temperature to 280° C., while that of the palladium membrane tube reactor (9) was increased from room temperature to 350° C. When the temperature rose, Ar was injected into the reactor as a protective gas. Once the temperature settings were reached, a liquid mixture of methanol and water was supplied by a pump (10) so that the methanol reacted with water in the steam reforming reactor (8) to produce H₂ and CO₂. Then, the resulting gas mixture was subjected to an H₂ purifying process for separation by passing through the palladium membrane tube reactor (9). A regulating valve (12) was adjusted to maintain a pressure of 10 absolute atmospheres inside the palladium membrane tube reactor (9). As a result, an H₂ permeation rate of 30 liters per hour was measured with an H₂ purity of 99.95%.

The above examples are intended to exemplify the embodiments of the subject invention and illustrate the technical features thereof, but not to limit the scope of protection of the subject invention. Any modifications or equivalent replacements that can be easily accomplished by persons skilled in the art are within the scope of the subject invention. The scope of the protection of the subject invention is based on the following claims as appended.

What is claimed is:

1. A palladium-containing electroplating solution, comprising:
about 2 g/L to about 200 g/L of palladium in palladium sulfate;
about 10 g/L to about 200 g/L of a reactive conductive salt;
about 10 g/L to about 150 g/L of a complexing agent; and
enough buffering agent to give the electroplating solution a pH of about 9 to about 12.

2. The electroplating solution of claim 1, comprising about 5 g/L to about 50 g/L of palladium in palladium sulfate, about 70 g/L to about 150 g/L of the reactive conductive salt, about 30 g/L to about 70 g/L of the complexing agent, and enough buffering agent to give the electroplating solution a pH of about 10 to about 11.

3. The electroplating solution of claim 1, wherein the reactive conductive salt is a SO₄²⁻ ion-providing compound.

4. The electroplating solution of claim 1, wherein the reactive conductive salt is selected from a group consisting of sodium chloride, potassium chloride, sodium sulfate, ammonium sulfate, ammonium chloride, sodium thiosulfate, ammonium thiosulfate, ammonium citrate, and combinations thereof.

5. The electroplating solution of claim 1, wherein the complexing agent is selected from a group consisting of boric acid, phosphate salts, hypophosphate salts, nitrate salts, tartrate salts, citrate salts, salts of ethylene diamine tetracetic acid (EDTA), and combinations thereof.

6. The electroplating solution of claim 1, wherein the complexing agent is selected from a group consisting of potassium nitrate, ammonium citrate, EDTA-Na₂, EDTA-Na₄, and combinations thereof.

7. The electroplating solution of claim 1, wherein the buffering agent is a hydroxide.

8. The electroplating solution of claim 1, wherein the buffering agent is selected from a group consisting of sodium hydroxide, potassium hydroxide, ammonium hydroxide, and combinations thereof.

9. The electroplating solution of claim 1, further comprising sulfuric acid in an amount sufficient for rendering the concentration of SO₄²⁻ in the electroplating solution to be about 0.2 mole to about 4 moles per liter.

10. The electroplating solution of claim 1, further comprising a second metal salt other than palladium sulfate and selected from a group consisting of: a copper salt, a silver salt, a gold salt, a nickel salt, a platinum salt, an indium salt, and combinations thereof.

11. The electroplating solution of claim 10, wherein the second metal salt is a copper salt selected from a group consisting of copper sulfate, copper chloride, and combinations thereof and in an amount sufficient for rendering the electroplating solution to contain about 0.2 g to about 100 g of copper per liter.

12. A method for providing a palladium or palladium alloy membrane on a porous metal support, comprising:
providing a porous metal support; and
electroplating a palladium or palladium alloy membrane onto the metal support with a palladium-containing electroplating solution, wherein said palladium-containing electroplating solution comprises:
about 2 g/L to about 200 g/L of palladium in a palladium salt;
about 10 g/L to about 200 g/L of a reactive conductive salt;
about 10 g/L to about 150 g/L of a complexing agent; and
enough buffering agent to give the electroplating solution a pH of about 9 to about 12.

13. The method of claim 12, wherein the porous metal support is composed of stainless steel.

14. The method of claim 12, wherein the electroplating step is carried out at an electroplating bath temperature ranging from about 40° C. to about 90° C. under a current density ranging from about 0.01 A/dm² to about 1.5 A/dm².

15. The method of claim 12, wherein the metal support is rotated during the electroplating step at a speed of not higher than about 1000 rpm.

16. The method of claim 15, wherein the metal support is rotated at a rate ranging from about 100 rpm to about 500 rpm.

17. The method of claim 12, wherein the palladium salt is selected from a group consisting of palladium sulfate, palladium tetrammine chloride (Pd(NH₄)₄Cl₂), palladium ammonium chloride (Pd(NH₄)₂Cl₄), palladium chloride, and combinations thereof.

18. The method of claim 12, further comprising coating a medium layer on the metal support prior to the step of electroplating the palladium or palladium alloy membrane.

19. The method of claim 18, wherein the medium layer is coated onto the metal support by an electroplating method and is composed of a material selected from a group consisting of nickel, copper, silver, gold, platinum, and combinations thereof.

20. The method of claim 12, wherein the electroplating step is a two-stage electroplating step, one stage of which uses palladium sulfate as the palladium salt and the other uses palladium chloride as the palladium salt.

21. A composite with a palladium or palladium alloy membrane, comprising:
a porous metal substrate;
a medium layer coated on a surface of the substrate; and
a palladium or palladium alloy membrane, coated on the medium layer,
wherein the palladium or palladium alloy membrane is substantially free from exfoliation under a condition that the pressure at the substrate side of the composite is up to about 3 absolute atmospheres higher than the pressure at its palladium or palladium alloy membrane side.

22. The composite of claim 21, wherein the porous metal substrate is composed of stainless steel.

23. The composite of claim 21, wherein the medium layer is composed of a material selected from a group consisting of nickel, copper, silver, gold, platinum, and combinations thereof.

24. The composite of claim 21, wherein the palladium or palladium alloy membrane is substantially free from exfoliation under a condition that the pressure at the substrate side of the composite is up to about 5 absolute atmospheres higher than the pressure at its palladium or palladium alloy membrane side.

25. The composite of claim 21, wherein the palladium or palladium alloy membrane is substantially free from exfoliation under a condition that the pressure at the substrate side of the composite is up to about 10 absolute atmospheres higher than the pressure at its palladium or palladium alloy membrane side.
